(19) United States
(12) Patent Application Publication
(10) Pub. No.: US 2025/0303760 A1
(43) Pub. Date: Oct. 2, 2025

(54) PRINTER

(71) Applicant: Toshiba Tec Kabushiki Kaisha, Tokyo (JP)

(72) Inventor: Kiyotaka NIHASHI, Mishima Shizuoka (JP)

(21) Appl. No.: 19/040,824

(22) Filed: Jan. 29, 2025

(30) Foreign Application Priority Data
Mar. 26, 2024 (JP) 2024-050016

(51) Int. Cl. B41J 15/04; B41J 3/407; B41J 11/04; B41J 29/13

(52) U.S. Cl. CPC B41J 15/042; B41J 3/4075; B41J 11/04; B41J 29/13

(57) ABSTRACT

A printer includes a housing including a storage unit for storing a rolled sheet, an opening through which the rolled sheet can be set, and first and second surfaces, the first and second surfaces being connected to each other, a cover rotatably attached to the housing to cover the opening, the cover being parallel to the first surface when covering the opening, a printing head configured to print on a portion of the rolled sheet, and a rolled sheet guide for retaining the rolled sheet in the storage unit. The rolled sheet guide moves from a first retaining position to a second retaining position that is closer to the cover than the first retaining position as the cover rotates to open, and moves from the second retaining position to the first retaining position as the cover rotates to close.

### CROSS-REFERENCE TO RELATED APPLICATION(S)

This application is based upon and claims the benefit of priority from Japanese Patent Application No. 2024-050016, filed Mar. 26, 2024, the entire contents of which are incorporated herein by reference.

### FIELD

Embodiments described herein relate generally to a printer.

### BACKGROUND

Printers that store a rolled, belt-shaped sheet in a storage unit of a housing and print on a portion of the sheet drawn out from the storage unit have been used. Some of such printers have a housing of a rectangular shape and can be used with a smaller surface down such that a user can put the printer on a small desk or the like. In such printers, when the orientation is changed, the rolled sheet in the housing moves from an appropriate position, and thus the remaining amount of the sheet cannot be correctly detected.

There is a known printer with a structure to press the rolled sheet so that the rolled sheet is kept at the appropriate position for detecting the remaining sheet amount. However, if the orientation of the printer is changed and the cover is opened laterally rather than upwardly, there is a possibility that the rolled sheet that is moved in the rolling direction will hinder the housing from being closed again.

### SUMMARY OF THE INVENTION

Embodiments of the present disclosure provide a printer capable of maintaining a rolled sheet at an appropriate position even when the bottom surface of a housing is changed.

A printer includes a housing including a storage unit for storing a rolled sheet, an opening through which the rolled sheet can be set, and first and second surfaces, the first and second surfaces being connected to each other, a cover rotatably attached to the housing to cover the opening, the cover being parallel to the first surface when covering the opening, a printing head configured to print on a portion of the rolled sheet, and a rolled sheet guide for retaining the rolled sheet in the storage unit. The rolled sheet guide moves from a first retaining position to a second retaining position that is closer to the cover than the first retaining position as the cover rotates to open, and moves from the second retaining position to the first retaining position as the cover rotates to close.

### BRIEF DESCRIPTION OF THE DRAWINGS

FIG. 1 is a perspective view illustrating an external appearance of a printer according to an embodiment.

FIG. 2 is a cross-sectional view illustrating an example of an internal structure of the printer.

FIG. 3 is a cross-sectional view of the printer used in a vertical placement.

FIG. 4 is a cross-sectional view of the printer used in the vertical placement.

FIG. 5 is a schematic diagram illustrating a positional relationship between a rolled sheet guide and a periphery thereof.

FIGS. 6A, 6B, and 6C are views for explaining movement of the rolled sheet guide in accordance with opening and closing of a lid portion.

FIG. 7 is a diagram illustrating a rolled sheet guide and a link unit moving inside a storage unit.

### DETAILED DESCRIPTION

Hereinafter, embodiments will be described in detail with reference to the drawings. The present invention is not limited to the embodiments described below.

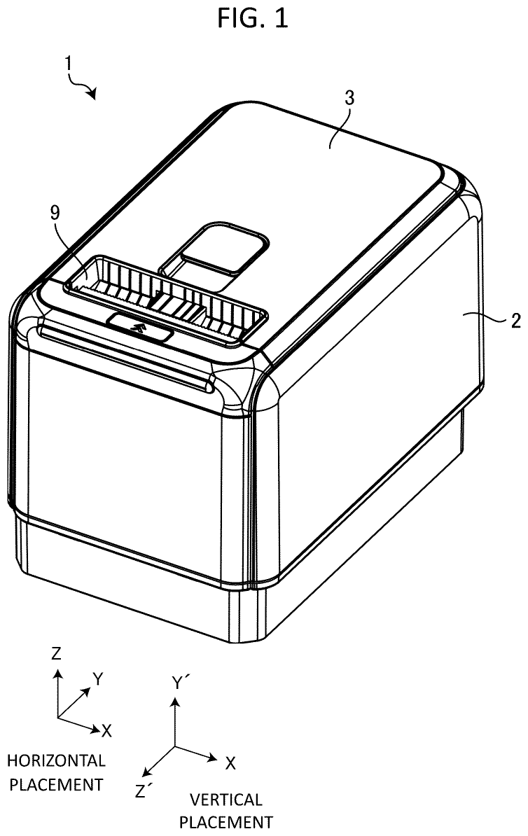

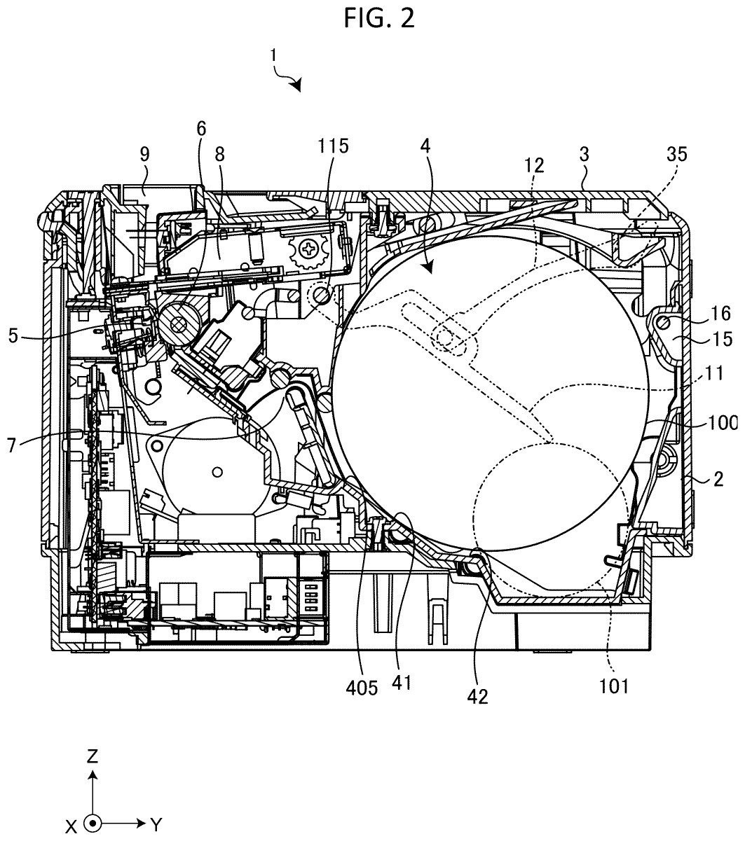

Embodiments will be described with reference to the drawings. FIG. 1 is a perspective view illustrating an external appearance of a printer 1 according to an embodiment. FIG. 2 is a cross-sectional view illustrating an example of an internal structure of the printer 1. The printer 1 includes a housing 2, a cover 3, a storage unit 4, a print head 5, a platen roller 6, a damper 7, a cutter unit 8, and the like. The print head 5 and the platen roller 6 constitute a printing unit.

The housing 2 is a container that has an opening that is opened and closed by the cover 3, and having other parts (i.e., the storage unit 4, the print head 5, the platen roller 6, the damper 7, the cutter unit 8, and the like) therein. The housing 2 has a substantially rectangular parallelepiped shape, and can be placed in a vertically long and horizontally long direction, so that the printer 1 can be used in both a horizontal placement in which the cover 3 opens upward and a vertical placement in which the cover 3 is pulled to open.

The perspective view of FIG. 1 shows a state in which the top surface, the front surface, and the right side surface of the printer 1 placed horizontally are visible, and the bottom surface, the rear surface, and the left side surface of the printer 1 are invisible. In the horizontal placement, the housing 2 is horizontally long with the cover 3 facing upward. The three-dimensional coordinate system for the horizontal placement is shown in X, Y, and Z axes. The X-axis direction is the width direction of the printer 1. The Y-axis direction is a depth direction of the horizontally placed printer 1. The Z-axis direction is a height direction of the horizontally placed printer 1.

The vertical placement is a placement method in which the housing 2 is vertically long. In the case where the printer 1 is placed vertically, the housing 2 depicted in FIG. 1 is rotated 90° clockwise about the X axis, so that the front surface of the front side in FIG. 1 faces upward, and the cover 3 is placed vertically and faces the rear side in FIG. 1. The three-dimensional coordinate system in the vertical placement is represented by X, Y′, and Z′ axes. The X-axis direction is the width direction of the printer 1 as in the case of horizontal placement. The Y′-axis direction is a depth direction of the printer 1 in the vertical placement. The Z′-axis direction is the height direction of the printer 1 in the vertical placement.

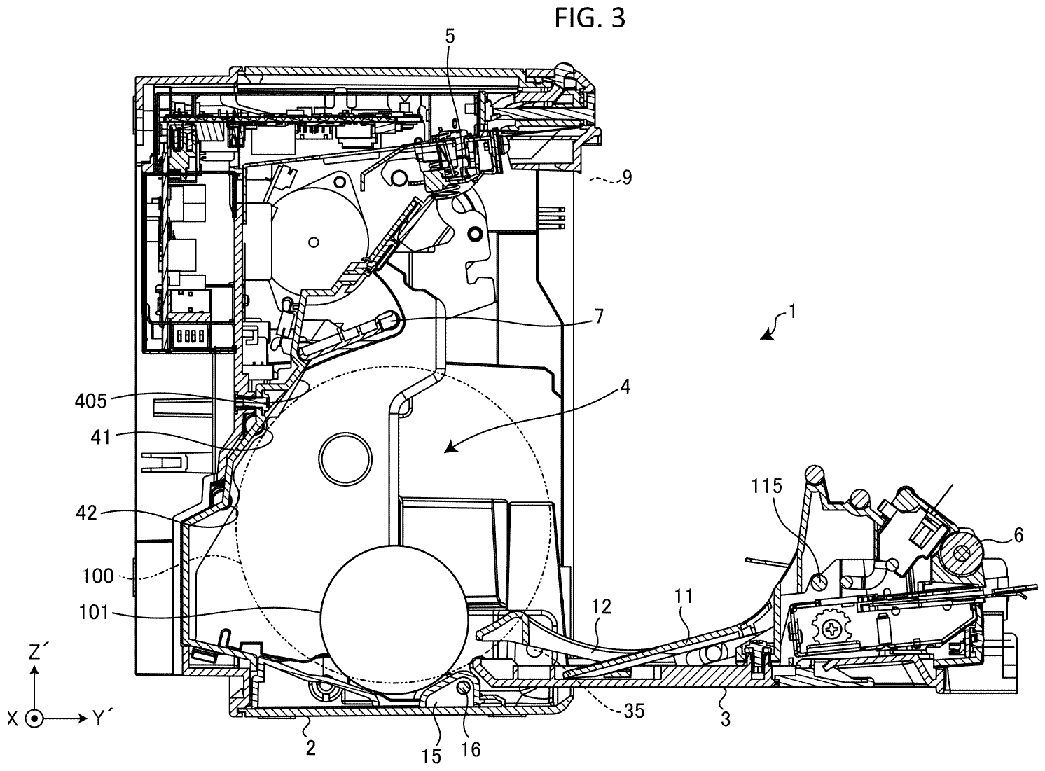

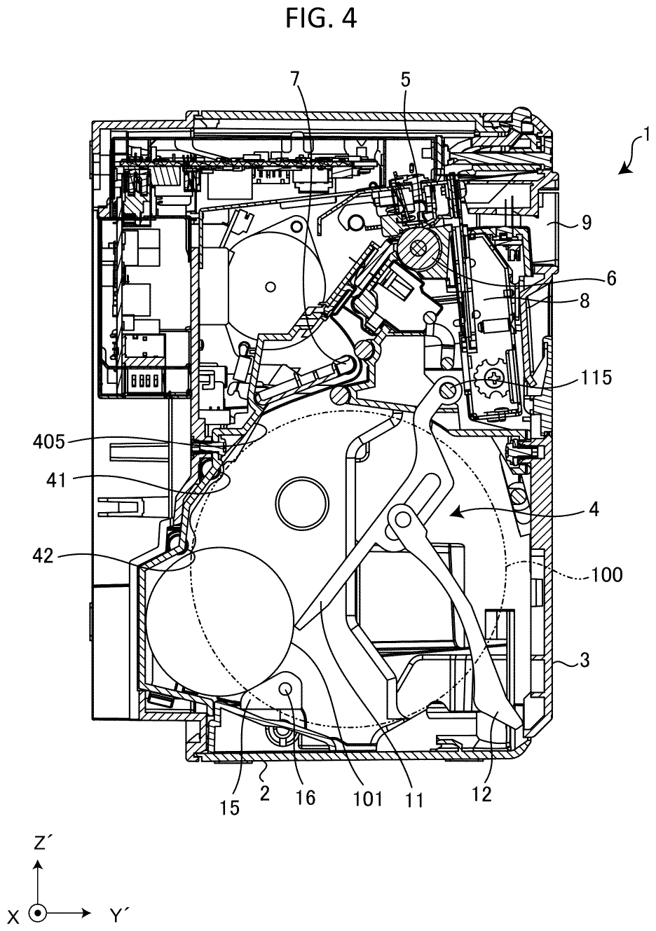

FIG. 3 and FIG. 4 are cross-sectional views of the printer 1 used in the vertical placement, in which FIG. 3 is a state in which the cover 3 is opened, and FIG. 4 is a state in which the cover 3 is closed. The vertical placement is a state where the printer 1 in the horizontal placement is rotated about 90° around the X axis as described above. Thus, the Y′ and Z′ axes shown in FIG. 3 are moved about 90° about the X axis from the Y and Z axes shown in FIG. 2.

The cover 3 is rotatably attached to the end of the opening of the housing 2 about a shaft 35 provided at one end portion, and moves between a closed position in which the opening of the housing 2 is closed and an open position in which the opening is opened in accordance with the rotation. In a state in which the cover 3 is positioned at the closed position, a sheet discharge port 9 is formed between the other end portion (i.e., the end portion opposite to the one end portion) of the cover 3 and the housing 2.

The rolled sheet 100 or 101 accommodated in the storage unit 4 are taken in and out from the opening of the housing 2 which is opened and closed by the cover 3. The storage unit 4 accommodates the rolled sheet 100 or 101 by defining its position in the width direction thereof. The rolled sheets 100 and 101 are formed by winding a belt-shaped sheet. Here, the illustrated rolled sheet 100 has a maximum diameter, and the rolled sheet 101 has a medium to minimum diameter. It is assumed that the rolled sheet 100 having the maximum diameter is in an unused condition. Further, the diameter of the rolled sheet 101 is assumed to be, for example, about half of the maximum diameter regardless of whether the sheet is unused or used.

When the printer 1 is used horizontally, the inner surface of the storage unit 4 is formed such that the rolled sheet 101 having a reduced diameter is positioned at the bottom (that is, the deepest position in the Z direction) so that the remaining amount can be detected by using a sensor provided at a predetermined position. The sensor is provided, for example, at a predetermined position inside the storage unit 4.

The sheet is a general sheet such as a receipt sheet, a sheet of labels each having a predetermined size attached to a strip-shaped mount, a strip-shaped label sheet without a mount (i.e., a label sheet without a base sheet), or the like. Note that, in the label sheet, a layer of an adhesive is provided on one side of a sheet (e.g., a back side of a printing surface). In addition to paper, the sheet may be a plastic film or the like.

The print head 5 prints on a sheet sandwiched between itself and the platen roller 6, and is, for example, a line thermal head in which a plurality of heating elements are arranged along the sheet width direction. The platen roller 6 is a cylindrical roller having elasticity on a surface thereof, and is rotationally driven about an axis by receiving a driving force of a motor or the like to convey a sheet with the print head 5.

The print head 5 is provided in the housing 2, the platen roller 6 is attached to the cover 3, and the print head 5 and the platen roller 6 come into contact with and separate from each other in accordance with the rotation movement of the cover 3. When the print head 5 and the platen roller 6 are separated from each other, the conveyance path of the sheet is opened.

The cutter unit 8 is attached to the cover 3, is provided on the downstream side in the sheet conveying direction from the print head 5 and the platen roller 6, and cuts the sheet after printing.

The cutter unit 8 includes, for example, a fixed blade and a movable blade. The fixed blade and the movable blade are arranged such that the cutting edges face each other and the conveyance path of the sheet is sandwiched in the sheet thickness direction. The fixed blade is fixed in the housing 2. The movable blade is attached to the cover 3 and moves in a direction to be brought into contact with and separated from the fixed blade by receiving a driving force. When the cutting edge of the movable blade slides with the cutting edge of the fixed blade, the sheet sandwiched between the cutting edges is cut.

In the printer 1 having such a configuration, the cover 3 is opened, the rolled sheet 100 or 101 is accommodated in the storage unit 4 in the housing 2, and a portion of the sheet drawn out from the rolled sheet 100 or 101 is positioned so as to be sandwiched between the print head 5 and the platen roller 6, and the cover 3 is closed. As a result, the printer 1 is in an operable state, that is, a printable state.

The printer 1 in operation drives the platen roller 6 and the print head 5 to perform printing on the sheet while conveying the sheet sandwiched between the platen roller 6 and the print head 5. The printer 1 also controls the cutter unit 8 so that the printed portion of the sheet is cut at an appropriate position. More specifically, drive control for moving the movable blade is performed.

When the sheet is a label sheet without a base sheet, the printer 1 waits for the cut sheet to be removed from the sheet discharge port 9 every time the cutter unit 8 cuts the sheet, and performs the next printing after the cut sheet is removed. For this control, the printer 1 includes a sheet discharge port sensor for detecting the presence or absence of a sheet in the sheet discharge port 9. In the printer 1 using the label sheet without a base sheet, printing can be performed when the sheet discharge port sensor does not detect the sheet.

The damper 7 is configured such that one side of the plate-shaped member is rotatably attached to a position on the downstream side of the holding surface 405 of the storage unit 4 in the sheet conveyance direction, and the opposite side swings along the sheet conveyance path. The damper 7 is biased by a biasing member in a direction in which the conveyance path of the sheet becomes longer, and rotates against the biasing when the tension of the sheet is high, and rotates in a direction to return to the original position according to the biasing when the tension of the sheet is low. Due to such movement, the damper 7 reduces the variation in the tension of the sheet sandwiched between the print head 5 and the platen roller 6, and reduces the sudden impact. In addition, the damper 7 absorbs fluctuations in the conveyance force required for conveyance of the sheet due to the rotation of the platen roller 6. It should be noted that the damper 7 may have the same function even if it is not of the shape shown in the drawings.

Here, the printer 1 further includes a flapper 11, a rotation restricting structure 12, a rolled sheet guide 15, a link structure 17, and the like. These are provided for controlling the position of the rolled sheet 101 in the storage unit 4.

The storage unit 4 is a so-called throw-in type or drop-in type. That is, it does not include a shaft or the like that holds the hollow portion of the rolled sheets 100 and 101. Therefore, in a case where the printer 1 is configured not to include the flapper 11, the rolled sheet 101 is more likely to move within the storage unit 4 as the diameter becomes smaller than the rolled sheet 100 having the maximum diameter that can be stored in the storage unit 4. If the rolled sheet 101 is freely moved in the storage unit 4, the function of detecting the remaining amount of the rolled sheet 101 by the remaining amount sensor provided at a predetermined position will not function well. The flapper 11 is provided to control the position of the rolled sheet 101 in the storage unit 4 to some extent, and to enable the remaining amount detection by the remaining amount sensor.

The flapper 11 is provided on an inner surface of the cover 3, and presses the outer peripheral surface of the rolled sheet 100 or 101 accommodated in the storage unit 4 in a direction away from the cover 3 when the cover 3 is in a position to close the opening portion. The flapper 11 is rotatably provided around a shaft 115 and is biased in the direction of the rolled sheet 100 or 101 accommodated in the storage unit 4.

The shaft 115 of the rotation of the flapper 11 is disposed along the X-axis at a position away from the shaft 35 on the inner surface of the cover 3. A biasing member such as a torsion spring is attached to the shaft 115, and the flapper 11 is biased by the biasing member in a direction of pressing the outer peripheral surface of the rolled sheet 100 or 101 accommodated in the storage unit 4.

The direction in which the flapper 11 is biased is, in other words, the direction in which the end of the flapper 11 remote from the shaft 115 is away from the cover 3. The rotation restricting structure 12 is a generally rod-shaped member, one end portion of which is rotatably supported by the cover 3, and the other end portion of which is movable along an elongated hole of the flapper 11. The rotation restricting structure 12 restricts a rotation range caused by the bias of the flapper 11 in a state in which the cover 3 is opened.

The rolled sheet 101 is pressed by the flapper 11, and is pressed against a position of the inner wall of the storage unit 4 away from the cover 3. As a result, the rolled sheet 101 is appropriately detected by the remaining amount sensor, and the remaining amount thereof is appropriately detected. The remaining amount detection may be performed by detecting the position of the flapper 11 in contact with the rolled sheet 100 or 101 or by detecting the outer peripheral positions of the rolled sheet 100 or 101 pressed to a predetermined position by the flapper 11. In the case of detecting the position of the flapper 11, the remaining amount sensor is provided at a predetermined position inside the cover 3 provided with the flapper 11, for example.

In a printer including the flapper 11 as described above, the cover may be opened and closed in a state in which the rolled sheet having a small diameter is inserted in various maintenance operations such as, for example, when a paper jam is dealt with. In such a case, the cover can be closed smoothly if the printer is in use in the horizontal placement, but when the printer is in use in the vertical placement, the rolled sheet rolled out to the vicinity of the cover due to the opening of the cover may interfere with the flapper or may enter between the flapper and the cover. In this case, the cover cannot be closed smoothly.

Also, even in a printer that does not include the flapper 11, if the rolled sheet 101 is located at an unintended location, inconvenience such as not being detected by the remaining amount sensor of the rolled sheet 101 may occur.

As described above, the rolled sheet guide 15 prevents inconvenience caused by the rolled sheet 101 being positioned at an unintended location and guides the rolled sheet to a predetermined location.

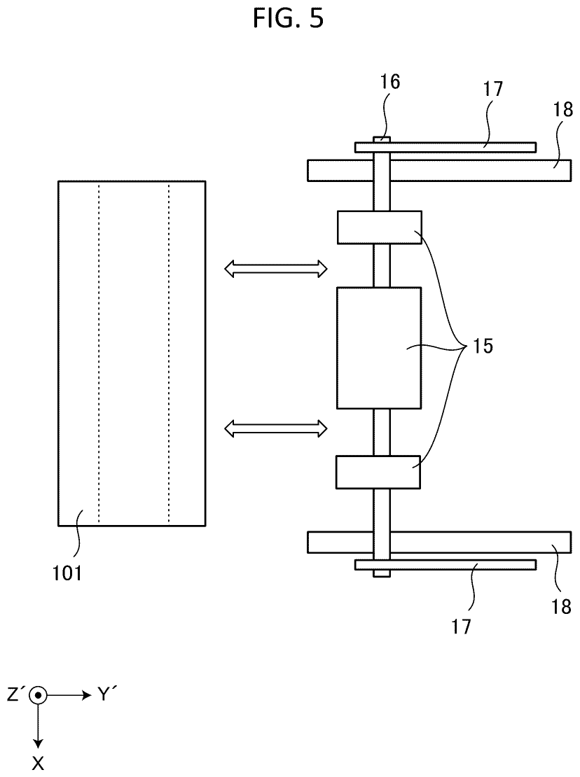

FIG. 5 is a diagram schematically showing the positional relationship between the rolled sheet guide 15 and the periphery thereof. FIG. 5 shows a state in which the rolled sheet guide 15 and its periphery are looked down from above when the printer 1 is placed vertically. As shown in FIG. 5, the rolled sheet guide 15 is provided mainly in a central portion in the width direction (i.e., X-axis direction) of the rolled sheet 101. In the printer 1, the rolled sheet 100 or 101 having a plurality of types of widths (e.g., 80 mm, 58 mm, and 40 mm) can be used, but when a force is applied to the widthwise center portions thereof, the rolled sheet can function as the rolled sheet guide 15.

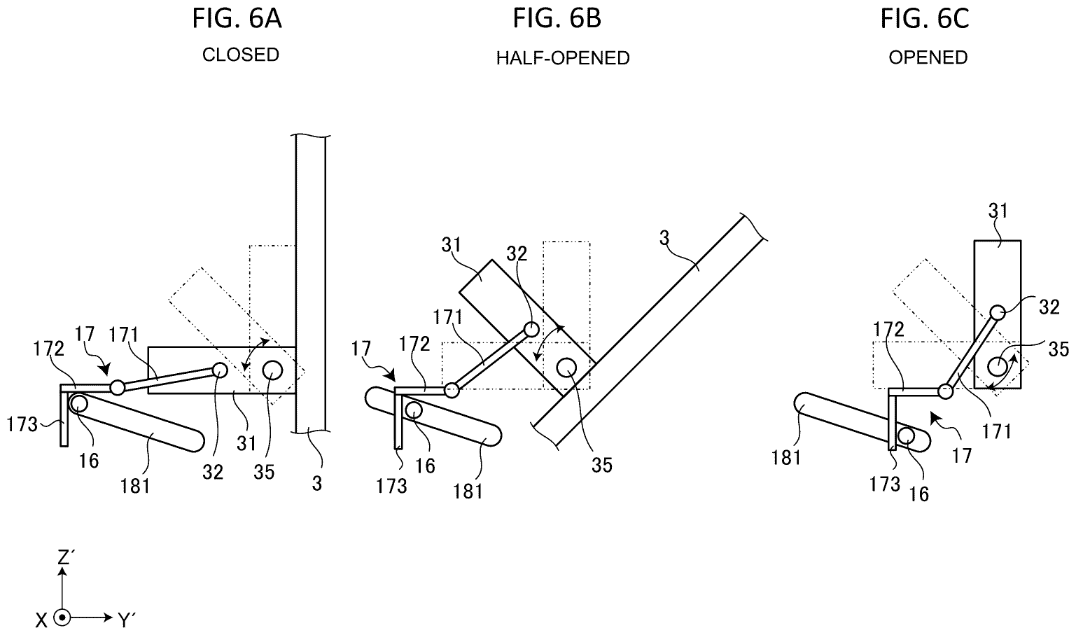

FIGS. 6A, 6B, and 6C are views for explaining movement of the rolled sheet guide 15 in accordance with opening and closing of the cover 3. FIGS. 6A-6C show states viewed from the same direction as that of FIG. 3 and FIG. 4. FIG. 6A shows a state in which the cover 3 is positioned at a position where the storage unit 4 is closed. FIG. 6B shows a state in which the cover 3 is positioned in the half-open position. FIG. 6C shows a state in which the cover 3 is positioned at a position where the storage unit 4 is fully opened.

The printer 1 includes a transmission mechanism including a support shaft 16, the link structure 17, a rail 181, and a connector 32. The transmission mechanism converts the rotation of the cover 3 and transmits the converted rotation to move the rolled sheet guide 15. In other words, the transmission mechanism transmits the movement of the cover 3 to the rolled sheet guide 15, and converts the opening and closing of the cover 3 into the movement of the rolled sheet guide 15. Thus, the transmission mechanism moves the rolled sheet guide 15 together with the opening and closing of the cover 3.

The support shaft 16 passes through the rolled sheet guide 15, is rotatable with respect to the rolled sheet guide 15, and supports the rolled sheet guide 15. Both end portions of the support shaft 16 are held by the rail 181 so as to be slidable. The rail 181 is, for example, a groove provided in a frame 18 that supports various components included in the housing 2 of the printer 1.

The connector 32 is provided on the protruding portion 31 protruding from the inner surface of the cover 3. As shown in FIGS. 6, the cover 3 includes a shaft 35 at the center of rotation in the convex portion 31. The connector 32 is provided at a position closer to the tip of the protrusion 31 than the shaft 35 (i.e., a position shifted in the direction of the protrusion). The link structure 17 is coupled to the connector 32. The connector 32 moves along an arc-shaped path in accordance with the rotation of the cover 3 about the shaft 35.

The link structure 17 connects the support shaft 16 and the connector 32, and includes three rod-shaped members, a first member 171, a second member 172, and a third member 173, which are connected to each other. One end portion of the first member 171 is rotatably connected to the connector 32, and the other end portion thereof is rotatably connected to one end portion of the second member 172. The other end of the second member 172 is rotatably connected to one end portion of the third member 173. The third member 173 holds the support shaft 16 of the rolled sheet guide 15 in a hooked state, for example. The link structure 17 moves along the rail 181 by receiving the movement of the connector 32 and moving the support shaft 16.

With such a configuration, the rolled sheet guide 15 moves along the longitudinal direction of the rail 181 as the cover 3 is opened and closed. The rail 181 is provided along a direction in which the rolled sheet guide 15 is desired to be moved. The direction in which the rolled sheet guide 15 is moved will be described next.

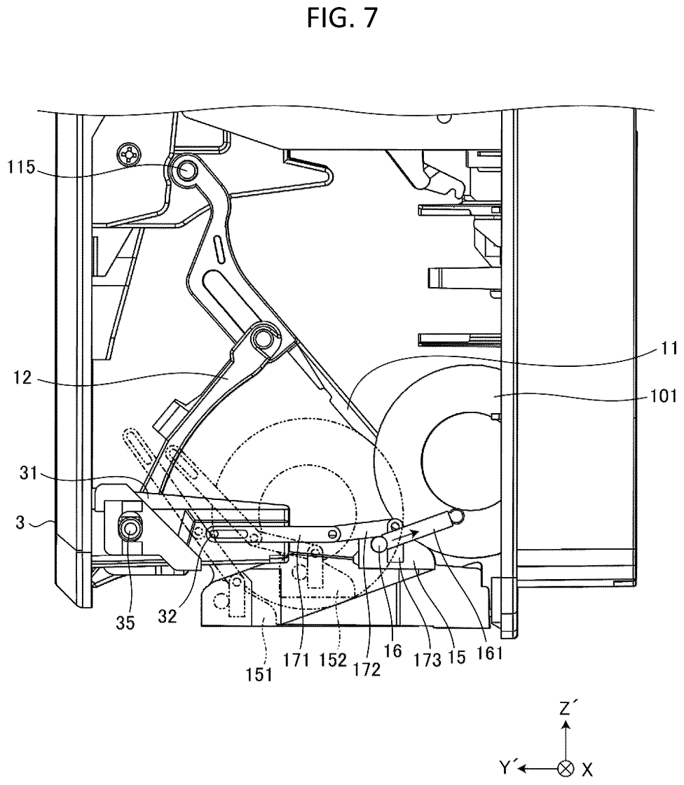

FIG. 7 is a diagram illustrating the rolled sheet guide 15 and the link structure 17 moving inside the storage unit 4. FIG. 7 shows a state of the printer 1 viewed from the opposite side of FIG. 3 and FIG. 4. Here, the support shaft 16 is biased by a biasing member 161 such as a helical spring in a direction away from the cover 3 (i.e., a left-right direction in FIG. 7).

When the cover 3 is closed, the rolled sheet guide 15 moves along the rail 181 to move in a direction away from the cover 3 while being substantially along the shape of the inner peripheral surface of the storage unit 4. When the cover 3 is opened, conversely, the rolled sheet guide 15 moves in a direction approaching the cover 3 from right to left in FIG. 7. When the cover 3 is opened, the rolled sheet guide 15 is located at a position close to the cover 3 in its movable range.

More specifically, the rolled sheet guide 15 moves along the rail 181 when the cover 3 is closed. The rolled sheet guide 15 in a state in which the cover 3 is opened is at a position indicated by a broken line indicated by reference numeral 151. The rolled sheet 101 guided by the rolled sheet guide 151 at this time is at a position indicated by another broken line.

The rolled sheet guide 15 in a state where the cover 3 is at the half-open position is at a position indicated by a broken line indicated by reference numeral 152. In addition, the rolled sheet guide 15 in a state in which the cover 3 is closed is at a position indicated by a solid line. The rolled sheet 101 guided by the rolled sheet guide 15 at this time is at a position indicated by a solid line.

In the case where the printer 1 as described above is placed vertically, the rolled sheet guide 15 (151, 152) comes into contact with the outer peripheral surface of the rolled sheet 101 inserted into the storage unit 4 from the lower side. The rolled sheet guide 15 moves the rolled sheet 101 in the same direction when it moves along the longitudinal direction of the rail 181.

As a result, the rolled sheet guide 15 moves the rolled sheet 101 in a direction away from the cover 3 to move the rolled sheet 101 to a predetermined position. The predetermined position in this case is, for example, a position at which the remaining amount can be detected using the remaining amount sensor as in the case of the printer 1 in the horizontal placement. As described above, the rolled sheet guide 15 guides the rolled sheet 101 to a position at which the remaining amount can be detected by the same remaining amount sensor even when the printer 1 is placed vertically or horizontally.

Here, the biasing force of the biasing member 161 will be supplemented. The biasing member 161 biases the rolled sheet guide 15 in a direction away from the cover 3 via the support shaft 16, but the biasing force is such that the rolled sheet 100 having the maximum diameter is not moved, and the rolled sheet 101 having approached the minimum diameter is moved to a predetermined position, but the rolled sheet 101 is not pushed up so as to separate the rolled sheet 101 and the inner peripheral surface of the storage unit 4. The biasing force of the biasing member 161 satisfying such an operation condition is determined in consideration of the type of the rolled sheet 100 used in the printer 1, the biasing force of the biasing member that biases the flapper 11, and the like.

As described above, even if the bottom surface of the housing 2 is changed, the rolled sheet 100 or 101 can be positioned at an appropriate position. Therefore, even if the position of the rolled sheet 100 or 101 accommodated in the housing 2 is changed by the selection of the bottom surface, the remaining amount of the sheet 100 or 101 can be detected correctly. Further, in a case where the cover 3 of the housing 2 is opened horizontally instead of upward, even if the rolled sheet 100 or 101 moves in the rolling direction from the opening, the rolled sheet 100 or 101 is moved along with the rotation of the cover 3. Therefore, there is no inconvenience such as that the rolled sheet 100 or 101 interferes with the flapper 11 or the like and hinders the closing of the cover 3.

Although the rolled sheet guide 15 is moved by the link structure 17 in the above embodiments, the present invention is not limited thereto, and the rolled sheet guide 15 may be moved by transmitting a driving force generated by a driving source such as a motor.

Further, the housing 2 has a rectangular parallelepiped shape and can be placed horizontally or vertically with at least one of the two adjacent surfaces selectively as a bottom surface, but the present invention is not limited thereto. For example, the housing 2 may not necessarily have a rectangular parallelepiped shape, and may be any shape capable of placing at least one of the two adjacent surfaces at a predetermined angle (e.g., about 90 degrees) as the bottom surface.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A printer comprising:
a housing including a storage unit for storing a rolled sheet, an opening through which the rolled sheet can be set, and first and second surfaces, the first and second surfaces being connected to each other;
a cover rotatably attached to the housing to cover the opening, the cover being parallel to the first surface when covering the opening;
a printing head configured to print on a portion of the rolled sheet; and
a rolled sheet guide for retaining the rolled sheet in the storage unit, wherein
the rolled sheet guide moves from a first retaining position to a second retaining position that is closer to the cover than the first retaining position as the cover rotates to open, and moves from the second retaining position to the first retaining position as the cover rotates to close.

2. The printer according to claim 1, wherein
an area of the first surface is greater than an area of the second surface.

3. The printer according to claim 1, further comprising:
a flapper that is biased to press the rolled sheet towards the first surface, wherein
when the cover rotates to close the opening, the rolled sheet guide moves the rolled sheet towards the first surface such that the flapper does not contact the rolled sheet.

4. The printer according to claim 3, further comprising:
a transmission mechanism by which a rotational movement of the cover is converted to a linear movement of the rolled sheet guide between the first and second retaining positions.

5. The printer according to claim 4, wherein
the transmission mechanism includes:
a pair of rails,
a shaft movable along the rails and to which the rolled sheet guide is attached,
a pair of connectors disposed around a rotation axis of the cover and movable along an arc according to rotation of the cover, and
a link structure that connects the connectors and the shaft and moves the shaft along the rails as the connectors move along the arc.

6. The printer according to claim 1, further comprising:
a discharge port from which the printed portion of the rolled sheet is discharged, wherein
the discharge port is formed in a gap between the cover and the housing.

7. The printer according to claim 1, wherein
the storage unit includes a recess that fits with the rolled sheet having a first diameter that is smaller than a predetermined threshold.

8. The printer according to claim 7, wherein
the rolled sheet guide retains the rolled sheet having the first diameter in the recess when the rolled sheet guide is at the first retaining position.

9. The printer according to claim 1, further comprising:
a platen roller by which the portion of the rolled sheet is drawn from the storage unit and pressed against the print head.

10. The printer according to claim 9, wherein
the print head is a thermal head including a plurality of heating elements, and
the rolled sheet is thermal paper.

11. A printer comprising:
a housing including a storage unit for storing a rolled sheet, an opening through which the rolled sheet can be set, and first and second surfaces, the first and second surfaces being connected to each other;
a cover attached along the second surface of the housing and rotatable between a first cover position at which the opening is fully covered and a second cover position at which the opening is fully opened, the cover being parallel to the first surface when the cover is at the first cover position;
a printing head configured to print on a portion of the rolled sheet; and
a rolled sheet guide for retaining the rolled sheet in the storage unit, the rolled sheet guide being movable between a first retaining position to a second retaining position that is closer to the cover than the first retaining position, wherein
the rolled sheet guide is at the first retaining position when the cover is at the first cover position and at the second retaining position when the cover is at the second cover position.

12. The printer according to claim 11, wherein
an area of the first surface is greater than an area of the second surface.

13. The printer according to claim 11, further comprising:
a flapper that is biased to press the rolled sheet towards the first surface, wherein
when the cover rotates from the second cover position to the first cover position, the rolled sheet guide moves the rolled sheet towards the first surface such that the flapper does not contact the rolled sheet.

14. The printer according to claim 13, further comprising:
a transmission mechanism by which a rotational movement of the cover is converted to a linear movement of the rolled sheet guide between the first and second retaining positions.

15. The printer according to claim 14, wherein
the transmission mechanism includes:
a pair of rails,
a shaft movable along the rails and to which the rolled sheet guide is attached,
a pair of connectors disposed around a rotation axis of the cover and movable along an arc according to rotation of the cover, and
a link structure that connects the connectors and the shaft and moves the shaft along the rails as the connectors move along the arc.

16. The printer according to claim 11, further comprising:
a discharge port from which the printed portion of the rolled sheet is discharged, wherein
the discharge port is formed in a gap between the cover and the housing.

17. The printer according to claim 11, wherein
the storage unit includes a recess that fits with the rolled sheet having a first diameter smaller than a predetermined threshold.

18. The printer according to claim 17, wherein
the rolled sheet guide retains the rolled sheet having the first diameter in the recess when the rolled sheet guide is at the first retaining position.

19. The printer according to claim 11, further comprising:
a platen roller by which the portion of the rolled sheet is drawn from the storage unit and pressed against the print head.

20. The printer according to claim 19, wherein
the print head is a thermal head including a plurality of heating elements, and
the rolled sheet is thermal paper.
